(19) United States
(12) Patent Application Publication
(10) Pub. No.: US 2017/0114643 A1
(43) Pub. Date: Apr. 27, 2017

(54) ROTOR HAVING AXIALLY SECURED SUPPORT RING

(71) Applicant: Siemens Aktiengesellschaft, Munich (DE)

(72) Inventors: Karsten Kolk, Mülheim a.d. Ruhr (DE); Peter Schröder, Essen (DE); Vyacheslav Veitsman, Gelsenkirchen (DE)

(73) Assignee: Siemens Aktiengesellschaft, Munich (DE)

(21) Appl. No.: 15/302,039

(22) PCT Filed: Mar. 31, 2015
(86) PCT No.: PCT/EP2015/056959

§ 371 Date: Oct. 5, 2016

(30) Foreign Application Priority Data
Apr. 15, 2014 (EP) 14164716.4

(51) Int. Cl. F01D 5/02; F01D 5/06

(52) U.S. Cl. CPC F01D 5/025; F01D 5/066; F05D 2260/30; F05D 2260/31; F05D 2260/33

(57) ABSTRACT

A rotor, in particular a gas turbine rotor, having a plurality of rotor disks which each have an axial through-opening and which are axially tensioned by at least one tension rod which extends through the through-openings and which are combined to form at least one rotor disk unit, wherein there abuts the outer diameter of the tension rod at least one support ring which is in engagement with one of the rotor disks and via which the tension rod is supported on the rotor disk. At least one securing element is provided for axially securing the at least one support ring. The securing element is fixed to the rotor disk to which the support ring is connected and is constructed such that it engages round an end face of the support ring, which face is directed away from the rotor disk.

### CROSS REFERENCE TO RELATED APPLICATIONS

This application is the US National Stage of International Application No. PCT/EP2015/056959 filed Mar. 31, 2015, and claims the benefit thereof. The International Application claims the benefit of European Application No. EP14164716 filed Apr. 15, 2014. All of the applications are incorporated by reference herein in their entirety.

### FIELD OF INVENTION

The present invention relates to a rotor, in particular a gas turbine rotor, having a plurality of rotor disks which each have an axial through-opening and which are axially tensioned by means of at least one tension rod which extends through the through-openings and which are combined to form at least one rotor disk unit, wherein there abuts the outer diameter of the tension rod at least one support ring which is in engagement with one of the rotor disks and via which the tension rod is supported on the rotor disk, and wherein at least one securing element is provided for axially securing the at least one support ring.

### BACKGROUND OF INVENTION

Such rotors which are composed of a large number of individual rotor disks so as to form one or more rotor disk units are known in the prior art in extremely varied constructions. The rotor disks of each rotor disk unit are pressed against each other in a planar manner via the tension rod, wherein the pressing force is normally produced by screw nuts which are screwed onto the tension rod at the end side. Generally, rotor disks which are arranged in a directly adjacent manner are further connected to each other and centered via a positive-locking connection. Such a positive-locking connection may be formed, for example, via a so-called serration.

During operation of the rotor, the rotor is subjected to oscillations whose frequency is dependent inter alia on the free-swinging length of the tension rod. With increasing construction length of a rotor, the free-swinging length of the tension rod also increases which results in the inherent frequency thereof being shifted to a lower level near the rotation frequency of the rotor. Such a frequency shift may involve inadmissibly high oscillation amplitudes which may impair the function of the rotor and may result in damage.

In order to reduce the free-swinging length of the tension rod, it is already known to fit at least one support ring to the outer diameter of the tension rod and to connect it to one of the rotor disks. The tension rod can be supported on the corresponding rotor disk via such a support ring. Thus, for example, DE 2643886 proposes a support ring in the form of a fitted ring having an expanding inner diameter, wherein the fitted ring engages with the free end thereof having a greater inner diameter in an annular groove which is provided on the associated rotor disk and which is supported with the smallest inner diameter on the tension rod. During operation, as a result of centrifugal force expansion of the rotor disk, the end of the fitted ring connected to the rotor disk is expanded so that the inner diameter of the fitted ring adjoining the outer periphery of the tension rod presses at the end side against the tension rod, whereby a secure tensioning between the rotor disk and the tension rod is achieved, and therefore the desired supporting action.

In order to prevent a support ring from being able to be displaced axially along the outer periphery of the tension rod, it is further known to axially secure the support ring by an additional securing element. Thus, for example, DE 2643886 proposes the use of a securing sleeve which is inserted between the support ring and an additional rotor disk and which is tensioned together with the rotor disks via the tension rod. If an additional rotor disk is not present, a dummy rotor disk must be used in order to be able to press the securing sleeve axially against the support ring. However, the use of such a dummy rotor disk involves high costs which is undesirable.

### SUMMARY OF INVENTION

On the basis of this prior art, an object of the present invention is to provide an alternative rotor of the type mentioned in the introduction.

In order to achieve this object, the present invention provides a rotor of the type mentioned in the introduction which is characterized in that the securing element is fixed to the rotor disk with which the support ring is in engagement and is constructed in such a manner that it engages round an end face of the support ring, which face is directed away from the rotor disk. According to the invention the support ring is therefore bordered in an axial direction, on the one hand, by the rotor disk to which it is connected and, on the other hand, by the securing element which is fixed to the same rotor disk. It is consequently not necessary to tension the securing element against the support ring via the tension rod. Accordingly, the use of a dummy rotor disk may be dispensed with which results in a simple and cheap construction.

The securing element is constructed in an annular manner. Accordingly, the support ring is axially secured over the entire periphery thereof.

According to an embodiment of the present invention, the support ring has an expanding inner diameter, wherein the support ring engages with the free end thereof having a greater inner diameter in an annular groove which is provided in the associated rotor disk. Consequently, the support ring according to the invention may be constructed, for example, similarly to the fitted ring which is disclosed in DE 2643886.

Advantageously, the securing element is constructed in one piece, whereby the production and assembly costs can be reduced.

The securing element is advantageously produced from metal.

According to an embodiment of the present invention, the securing element when viewed in cross-section has a fixing member which adjoins the associated rotor disk, a securing member which engages round the end face of the support ring, which face is directed away from the rotor disk, and a connection member which connects the fixing member and the securing member to each other. In this manner, a very simple construction is achieved.

The securing element is advantageously fixed to the associated rotor disk by means of screws which are advantageously provided with a loss prevention means. Thus, for example, the screws may be caulked.

According to an embodiment of the present invention, the securing element is fixed to an associated rotor disk by means of a bayonet connection. Such a bayonet connection allows simple assembly and disassembly of the securing element on the corresponding rotor disk.

The securing element advantageously has in a state distributed over the periphery thereof radially projecting bayonet projections which engage in an annular bayonet groove which is provided in the associated rotor disk and which is provided with bayonet projection receiving openings which are formed so as to correspond to the bayonet projections and which allow axial insertion of the bayonet projections into the bayonet groove. The rotor disk can accordingly be readily introduced axially into the bayonet groove of the rotor disk and can be fixed by rotation.

Advantageously, the securing element is secured against rotation using at least one securing pin. In this manner, inadvertent release of the bayonet connection is reliably prevented.

The present invention further relates to the use of a securing element for axially securing a support ring of a rotor according to the invention.

### BRIEF DESCRIPTION OF THE DRAWINGS

Additional features and advantages of the present invention will become clear with reference to the following description of a rotor according to an embodiment of the present invention and the appended drawings, in which:

FIG. 1 is a schematic view of a rotor according to the present invention;

FIG. 2 is an enlarged view of the cutout which is designated II in FIG. 1 and which shows an arrangement according to a first embodiment of the present invention;

FIG. 3 is a perspective view of a rotor disk according to a second embodiment of the present invention;

FIG. 4 is a perspective view of a securing element according to the second embodiment of the present invention; and

FIG. 5 is a perspective enlarged view of the cutout which is designated II in FIG. 1 and which shows an arrangement according to the second embodiment of the present invention.

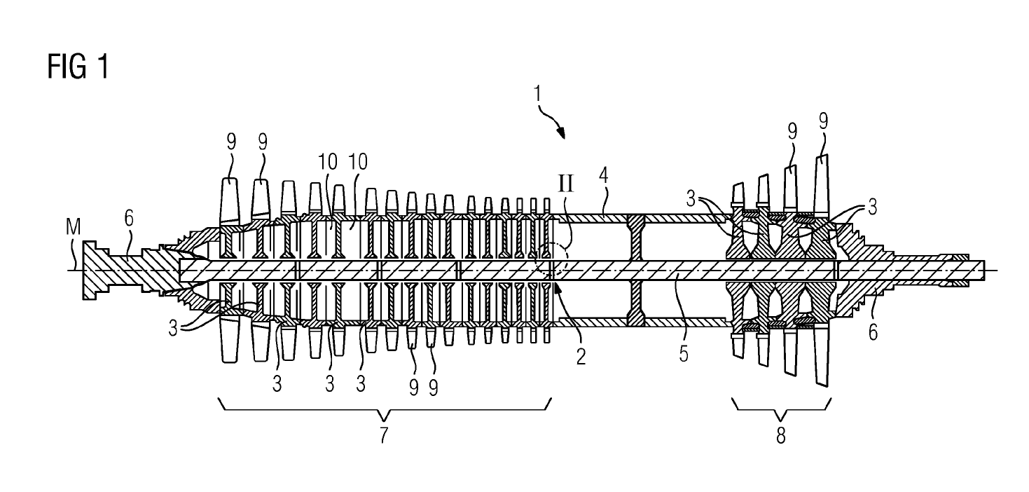

### DETAILED DESCRIPTION OF INVENTION

The rotor 1 which forms a gas turbine rotor in this case comprises a large number of rotor disks 3 which each have an axial through-opening 2, a hollow shaft 4 and a tension rod 5 which extends through the through-openings 2 and the hollow shaft 4 and via which the rotor disks 3 and the hollow shaft 4 are axially tensioned in a known manner using tension members 6 which are screwed onto the tension rod 5 at the end side. In this instance, the rotor disks 3 are combined to form a compressor-side rotor disk unit 7 and a turbine-side rotor disk unit 8, wherein the hollow shaft 4 is arranged between the two rotor disk units 7 and 8. The mutually facing end faces of rotor disks 3 which are arranged in a directly adjacent manner are provided with a serration which is not illustrated in greater detail, whereby, in addition to the tension resulting from the tension rod 5, there is also achieved a positive-locking connection between the corresponding rotor disks 3 and a centering with respect to the center axis M of the rotor 1. Rotating blades 9 are arranged at the outer periphery of the respective rotor disks 3. Recesses 10 which are provided between the rotor disks 3 serve to guide a cooling medium for cooling the rotor disks 3 by cooling air being supplied via a cooling channel which is formed between the tension rod 5 and the rotor disks 3 or the hollow shaft 4, respectively.

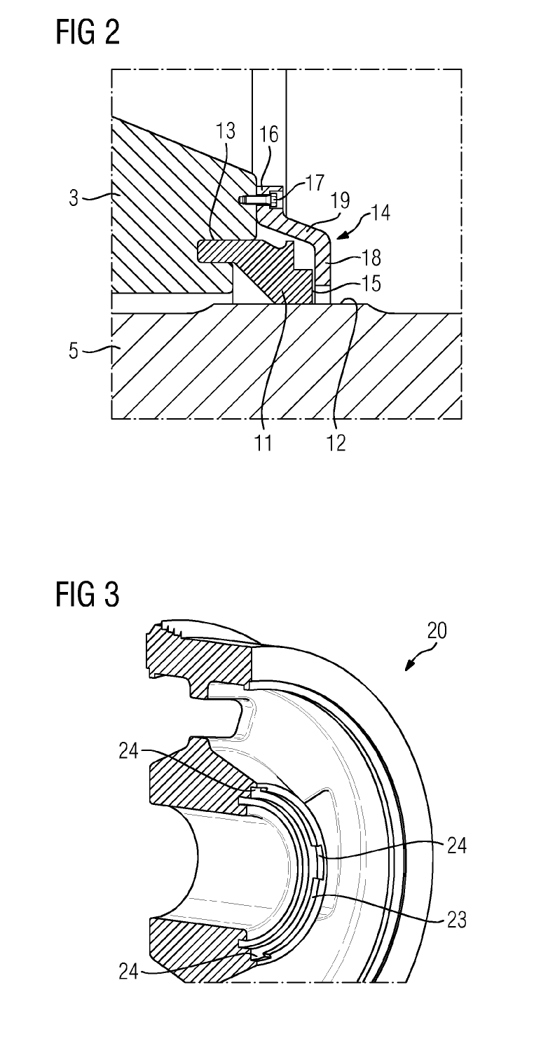

As a result of the great length of the tension rod 5, there adjoin the outer diameter thereof a plurality of support rings 11 which, as illustrated in FIG. 2, are each in engagement with one of the rotor disks 3 in such a manner that the tension rod 5 is supported on the corresponding rotor disks 3 via the support rings 11. Each of the support rings 11 is arranged on a step 12 of the tension rod 5 and has an expanding inner diameter, wherein the free end having the greater inner diameter engages in an annular groove 13 which is provided in the rotor disk 3 which is arranged in an adjacent manner. In order to axially secure the support rings 11, there are provided securing elements 14 which are each fixed to the rotor disk 3 on which the associated support ring 11 also acts. The securing elements 14 are formed in such a manner that they engage round an end face 15 of the associated support ring 11, which face is directed away from the associated rotor disk 3. Each securing element 14 is produced in one piece from metal and is formed in an annular manner. When viewed in cross-section, each securing element 14 comprises a fixing member 16 which adjoins the associated rotor disk 3 and which is fixed to the associated rotor disk 3 by means of non-releasable screws 17, a securing member 18 which engages round the end face 15 of the associated support ring 11, which face is directed away from the rotor disk 3, and a connection member 19 which connects the fixing member 16 and the securing member 18 to each other.

During operation, as a result of centrifugal force expansion of the rotor disks 3 with which a support ring 11 is in engagement, the free ends of the support rings 11 received in one of the annular grooves 13 are expanded so that the inner diameters of the support rings 11 adjoining the outer periphery of the tension rod 5 press at the end side against the tension rod 5, whereby a secure tensioning between the corresponding rotor disks 3 and the tension rod 5 is achieved, and therefore the desired supporting action. In this case, the support rings 11 are secured axially by the associated securing elements 14.

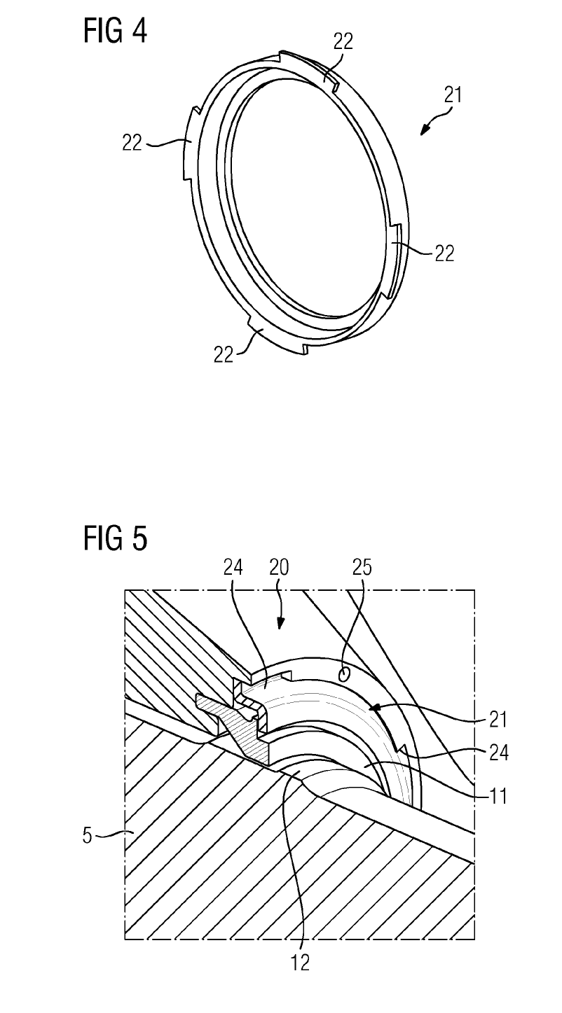

FIGS. 3 to 5 show an alternative embodiment of a rotor disk 20 and a securing element 21 of an arrangement according to a second embodiment of the present invention which can be used in place of the arrangement illustrated in FIG. 2. In the arrangement illustrated in FIG. 5, the support ring 11 is axially secured by the securing element 21 which is in turn fixed to the rotor disk 20 by means of a bayonet connection. In order to produce the bayonet connection, the securing element 21 which is further formed similarly to the securing element 14 of the first embodiment has bayonet projections 22 which project radially in a state distributed over the periphery thereof and which engage in an annular bayonet groove 23 which is provided in the associated rotor disk 20 and which is provided with bayonet projection receiving openings 24 which are formed so as to correspond to the bayonet projections 22 and which allow axial insertion of the bayonet projections 22 into the bayonet groove 23. Accordingly, the securing element 21 can be axially fitted over the support ring 11, wherein the bayonet projections 22 are introduced into the associated bayonet projection receiving openings 24, after which the bayonet projections 22 are axially fixed by the securing element 21 being rotated. In this instance, radial securing against rotation is produced by a securing pin 25 which is inserted in a hole of the rotor disk 20 extending in an axial direction and is pressed therein.

A substantial advantage of the securing elements 14, 21 according to the invention is that they are not tensioned against the associated support rings 11 via the tension rod 5, for which reason they can be mounted in a simple and cheap manner independently of the position thereof. Retrofitting is also possible without great complexity. As a result of the simple construction thereof, the securing elements 14, 21 can further be produced in a cost-effective manner.

Although the invention has been illustrated and described in greater detail by the preferred embodiment, the invention is not limited by the disclosed examples and other variations can be derived therefrom by the person skilled in the art without departing from the protective scope of the invention.

1.-11. (canceled)

12. A rotor, comprising:
a plurality of rotor disks each having an axial through-opening and which are axially tensioned by at least one tension rod which extends through the through-openings and which are combined to form at least one rotor disk unit,
at least one support ring that abuts the outer diameter of the tension rod, wherein the at least one support ring is in engagement with one of the rotor disks and supports the tension rod on the associated rotor disk, and
at least one securing element that axially secures the at least one support ring,
wherein the securing element is constructed in an annular manner and, when viewed in cross-section, has a fixing member which is fixed in an adjoining manner to the associated rotor disk and a securing member which engages round an end face of the support ring, which face is directed away from the rotor disk, and a connection member which connects the fixing member and the securing member to each other.

13. The rotor as claimed in claim 12,
wherein the support ring has an expanding inner diameter and engages with the free end thereof having a greater inner diameter in an annular groove which is provided in the associated rotor disk.

14. The rotor as claimed in claim 12,
wherein the securing element is constructed in one piece.

15. The rotor as claimed in claim 12,
wherein the securing element is produced from metal.

16. A rotor, comprising:
a plurality of rotor disks each having an axial through-opening and which are axially tensioned by at least one tension rod which extends through the through-openings and which are combined to form at least one rotor disk unit,
at least one support ring that abuts the outer diameter of the tension rod, wherein the at least one support ring is in engagement with one of the rotor disks and supports the tension rod on the associated rotor disk, and
at least one securing element that axially secures the at least one support ring,
wherein the securing element is constructed in an annular manner and is fixed to the associated rotor disk by means of screws and engages round an end face of the support ring, which face is directed away from the associated rotor disk.

17. The rotor as claimed in claim 16,
wherein the screws are provided with a loss prevention device.

18. The rotor as claimed in claim 16,
wherein the support ring has an expanding inner diameter and engages with the free end thereof having a greater inner diameter in an annular groove which is provided in the associated rotor disk.

19. The rotor as claimed in claim 16,
wherein the securing element is constructed in one piece.

20. The rotor as claimed in claim 16,
wherein the securing element is produced from metal.

21. A rotor, comprising:
a plurality of rotor disks each having an axial through-opening and which are axially tensioned by means of at least one tension rod which extends through the through-openings and which are combined to form at least one rotor disk unit,
at least one support ring that abuts the outer diameter of the tension rod, wherein the at least one support ring is in engagement with one of the rotor disks and supports the tension rod on the associated rotor disk, and
at least one securing element that axially secures the at least one support ring,
wherein the securing element is constructed in an annular manner and is fixed to the associated rotor disk by means of a bayonet connection and engages round an end face of the support ring, which face is directed away from the associated rotor disk.

22. The rotor as claimed in claim 21,
wherein the securing element has in a state distributed over the periphery thereof radially projecting bayonet projections which engage in an annular bayonet groove which is provided in the associated rotor disk and which is provided with bayonet projection receiving openings which are formed so as to correspond to the bayonet projections and which allow axial insertion of the bayonet projections into the bayonet groove.

23. The rotor as claimed in claim 21,
wherein the securing element is secured against rotation using at least one securing pin.

24. The rotor as claimed in claim 21,
wherein the support ring has an expanding inner diameter and engages with the free end thereof having a greater inner diameter in an annular groove which is provided in the associated rotor disk.

25. The rotor as claimed in claim 21,
wherein the securing element is constructed in one piece.

26. The rotor as claimed in claim 21,
wherein the securing element is produced from metal.

27. The rotor as claimed in claim 12,
wherein the rotor comprises a gas turbine rotor.

28. The rotor as claimed in claim 16,
wherein the rotor comprises a gas turbine rotor.

29. The rotor as claimed in claim 21,
wherein the rotor comprises a gas turbine rotor.
